(19) United States
(12) Patent Application Publication
(10) Pub. No.: US 2026/0040058 A1
(43) Pub. Date: Feb. 5, 2026

(54) MULTI-CONVERSION ANONYMOUS PRIVATE SET INTERSECTION TECHNIQUES

(71) Applicants: Beijing Zitiao Network Technology Co., Ltd., Beijing (CN); Lemon Inc., Grand Cayman (KY)

(72) Inventors: Haohao QIAN, Beijing (CN); Jian DU, Culver City, CA (US); Yongchuan NIU, Beijing (CN); Yongjun ZHAO, Beijing (CN); Li WANG, Beijing (CN); Qiang YAN, Beijing (CN)

(21) Appl. No.: 19/225,624

(22) Filed: Jun. 2, 2025

Related U.S. Application Data
(63) Continuation of application No. PCT/CN2024/109285, filed on Aug. 1, 2024.

(51) Int. Cl. H04W 12/02; G06F 21/62

(52) U.S. Cl. CPC H04W 12/02; G06F 21/6254; G06F 21/6263

(57) ABSTRACT

Systems and techniques described herein provide private set intersection (PSI) algorithms or protocols that improve the identification of “multi-conversion” within usage datasets while also keeping the users in the datasets anonymous during PSI operations. In some implementations, a first and a second dataset are dispatched. A first intersection operation is performed based on the first dataset and the second dataset. A second intersection operation is then performed based on the result of the first intersection operation. A third dataset is generated based on the first and second intersection operations, where the third dataset includes one or more identifications reflecting a multi-conversion event.

### CLAIM OF PRIORITY

This application claims priority under 35 USC § 120 to International Patent Application No. PCT/CN2024/109285 filed Aug. 1, 2024, the entire contents of which are hereby incorporated by reference.

### TECHNICAL FIELD

The embodiments described herein pertain generally to protecting membership privacy. More specifically, the embodiments described herein pertain to protecting membership (of an element, a member, a user, etc.) privacy in a secure multi-party computation and/or communication.

### BACKGROUND

Private set intersection (PSI) often refers to a cryptographic technique that allows two parties to find the intersection of their respective sets without revealing any other elements outside of the intersection to each other. In some instances, PSI is one of secure two-or multi-party protocols or algorithms by which intersection-related statistics are computed. PSI algorithms or protocols sometimes permit two or more organizations to jointly compute a function (e.g., count, sum) over the intersection of their respective data sets without revealing to the other party the intersection explicitly.

In some applications, two parties may be unwilling or unable to reveal the underlying data to each other, but they may still want to compute an aggregate population-level measurement. The two parties may want to do so while ensuring that the input data sets reveal nothing beyond these aggregate values about individual users.

In the context of content publication systems, an intersection operation may refer to the process of targeting a specific audience by combining multiple targeting criteria or attributes. For instance, a content publisher may target users who are interested in one or more topics (e.g., technology, gaming). An intersection operation may be used to target users who belong to both of these categories. An advertisement may only be displayed to users who meet both criteria, ensuring that the ad reaches a highly relevant audience. Intersection operations may be used in programmatic advertising platforms where advertisers can specify various targeting parameters (e.g., demographics, interests, behavior, location), and the platforms may combine these criteria using intersection operations to identify the most relevant audience for content.

### SUMMARY

Embodiments disclosed herein provide PSI algorithms or protocols that improve the identification of “multi-conversion” within usage datasets while also keeping the users in the datasets anonymous during PSI operations. In the context of PSI operations, “multi-conversion” refers to scenarios where a single user performs multiple valuable actions as a result of an advertising campaign. These conversions can include a variety of actions, such as making a purchase, signing up for a newsletter, downloading a brochure, or any other activity that may be deemed significant.

The PSI operations described herein may be based on, e.g., a differential privacy (DP) protocol or algorithm. Features in the embodiments disclosed herein may help to prevent potential membership leakage or exposure during the PSI operations, by e.g., integrating a protocol or algorithm with the DP protocol or algorithm for datasets or intersection of datasets having one or more Personal Identification Information (PII) for each user or member in the records or rows of the datasets or intersection of datasets.

Features in the embodiments disclosed herein may generate padding or filling elements for each party's dataset independently following a pre-calibrated distribution of noise, add the padding elements to each dataset, and execute a PSI algorithm or protocol. Further features in the embodiments disclosed herein may lead to the intersection size revealed in the subsequent PSI operations being random and differentially private, making it almost impossible for an attacker to determine a user's membership to a dataset or organization, in compliance with privacy regulation requirements.

In one example embodiment, a method for protecting membership in secure multi-party computation and communication is provided. The method includes dispatching a first dataset that includes (i) a first set of identifications of a first identification field, and (ii) a second set of identifications of a second identification field. The method also includes dispatching a second dataset that includes (i) a third set of identifications of the first identification field, and (ii) a fourth set of identifications of the second identification field.

Further, a first intersection operation is performed based on the first dataset and the second dataset. The first intersection operation includes identifying a first subset of identifications from among the third set of identifications, where the first subset of identifications includes each identification of the first identification field that matches an identification in the first set of identifications. The first intersection operation also includes identifying a second subset of identifications from among the third set of identifications, where the second subset of identifications comprises each identification of the first identification field that does not match an identification in the first set of identifications. The first intersection operation then includes identifying, from amongst the fourth set of identifications, a third subset of identifications that correspond to the first subset of identifications within the second dataset. Additionally, a fourth subset of identifications that correspond to the second subset of identifications within the second dataset is identified from amongst the fourth set of identifications.

The method also includes performing a second intersection operation based on the fourth subset of identifications. The second intersection operation includes identifying a fifth subset of identifications from among the fourth subset of identifications, where the fifth subset of identifications includes each identification of the second identification field that matches an identification of the second set of identifications. The second intersection operation also includes identifying, from amongst the third set of identifications, a sixth subset of identifications that correspond to the fifth subset of identifications within the second dataset.

The method further includes generating a third dataset based on the first subset of identifications, the second subset of identifications, the fifth subset of identifications, and the sixth subset of identifications.

One or more examples may include the following optional features. For example, in some examples, the method also includes generating a first share based on the third dataset, and constructing a result based on the first dataset and a second share.

In some examples, the method includes performing an oblivious transfer to generate a first noise data and applying the first noise data to the first share. For instance, the performing of the oblivious transfer includes generating a second noise data. In such instances, the method further includes applying the second noise data to the second share.

In some examples, the method further includes generating a padding dataset, a size of the padding dataset being determined based on a data privacy configuration. For instance, the data privacy configuration includes a first parameter and a second parameter. In such instances, the size of the padding dataset is determined such that the first intersection operation and second intersection operation are differentially private based on the first parameter and the second parameter. In other instances, the size of the padding dataset is determined based on a number of identification fields of the first dataset. In some other instances, the size of the padding dataset is determined further based on a number of intersection operations.

In some examples, the first dataset is up-sampled with the padding dataset by inserting elements of the padding dataset and random elements into a first baseline dataset. Further, in such examples, the second dataset is up-sampled with the padding dataset by inserting elements of the padding dataset and random elements into a second baseline dataset.

In some examples, the first dataset is associated with a first party and the second dataset is associated with a second party. In such instances, the first dataset is dispatched such that personally identifiable information associated with the first dataset is not accessible by the second party. Additionally, the first dataset is dispatched such that personally identifiable information associated with the second dataset is not accessible by the first party.

In some examples, the first dataset is constructed such that the first set of identifications and the second set of identifications do not include any duplicate identifications. In such examples, the second dataset is constructed such that the third set of identifications and the fourth set of identifications each include duplicate identifications. Further, the third dataset includes one or more identifications reflecting a multi-conversion event.

In another example embodiment, a secure multi-party computation and communication system is provided. The system includes a memory configured to store a first dataset. The system also includes a processor configured to generate a padding dataset, a size of the padding dataset being determined based on a data privacy configuration. The processor is also configured to up-sample the first dataset with the padding dataset by inserting elements of the padding dataset and random elements into the first dataset, transform the first dataset, and dispatch the first dataset. The processor is further configured to perform a first intersection operation based on the first dataset and a second dataset to identify a subset of identifications from the second dataset, and perform a second intersection operation based on the subset of identifications and identifications included in the first dataset to generate a third dataset. The third dataset includes one or more identifications reflecting a multi-conversion event, where the second intersection operation is performed such that identifications included in the first dataset are not removed prior to matching identifications included in the subset of identifications. Additionally, the processor is configured to generate a first share based on the third dataset, and construct a result based on the first share and a second share.

One or more examples may include the following optional features. For example, in some examples, the first dataset is associated with a first party and the second dataset is associated with a second party. In such examples, the first dataset is constructed such that personally identifiable information associated with the first dataset is not accessible by the second party, and the first dataset is constructed such that personally identifiable information associated with the second dataset is not accessible by the first party.

In some examples, the first dataset is constructed such that the first dataset does not include any duplicate identifications, and the second dataset is constructed such that the second dataset includes duplicate identifications.

Other embodiments of these aspects include corresponding systems, apparatus, and computer programs, configured to perform the actions of the methods, encoded on computer storage devices. For instance, non-transitory computer-readable medium having computer-executable instructions stored thereon that, upon execution, cause one or more processors to perform operations.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Non-limiting and non-exhaustive descriptions are described with reference to the following drawings. The components in the figures are not necessarily to scale, emphasis instead being placed upon illustrating principles. In the detailed description that follows, embodiments are described as illustrations only since various changes and modifications may become apparent to those skilled in the art from the following detailed description.

FIG. 1 is a schematic view of an example secure computation and communication system

FIG. 2 is a flow chart illustrating an example processing flow for a multi-identification matching algorithm.

FIG. 3 is a flow chart illustrating an example processing flow for matching logic enabling multi-conversion matching.

FIG. 4 is a schematic diagram illustrating an example of the processing flows of FIGS. 2 and 3.

FIGS. 5A, 5B-1, and 5B-2 show portions of a schematic diagram illustrating an example of processing flow of FIG. 3.

FIG. 6 is a schematic structural diagram of an example computer system applicable to implementing an electronic device, arranged in accordance with at least some embodiments described herein.

### DETAILED DESCRIPTION

Embodiments of the present disclosure will be described in more detail below with reference to the accompanying drawings. Although some embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for illustrative purposes and are not intended to limit the scope of protection of the present disclosure.

In the description of the embodiments of the present disclosure, the term “including,” and similar terms should be understood as open-ended inclusion, that is, “including but not limited to.” The term “based on” should be understood as “at least partially based on.” The terms “one embodiment” or “the embodiment” should be understood as “at least one embodiment.” The term “some embodiments” should be understood as “at least some embodiments.” Other explicit and implicit definitions may also be included below.

Unless expressly stated, performing a step “in response to A” does not mean that the step is performed immediately after “A,” but may include one or more intermediate steps.

Data involved in the present technical solution (including but not limited to the data itself, the acquisition, use, storage, or deletion of the data) should comply with requirements of corresponding laws and regulations and relevant rules.

Before applying the technical solutions disclosed in various embodiments of the present disclosure, a relevant user should be informed of the type, scope of use, and use scenario of the personal information involved in the subject matter described herein in an appropriate manner in accordance with relevant laws and regulations, and user authorization should be obtained, wherein the relevant user may include any type of rights subject, such as individuals, enterprises, groups.

Additionally, the present disclosure may be described herein in terms of functional block components and various processing steps. It should be appreciated that such functional blocks may be realized by any number of hardware and/or software components configured to perform the specified functions.

As referenced herein, a “data set” or “dataset” is a term of art and may refer to an organized collection of data stored and accessed electronically. In an example embodiment, a dataset may refer to a database, a data table, a portion of a database or data table, etc. A dataset may correspond to one or more database tables, of which every column of a database table represents a particular variable or field, and each row of the database table corresponds to a given record of the dataset. The dataset may list values for each of the variables, and/or for each record of the dataset. A dataset may also or alternatively refer to a set of related data and the way the related data is organized. In an example embodiment, each record of a dataset may include field(s) or element(s) such as one or more predefined or predetermined identifications (e.g., membership identifications, user identifications, etc., such as user's nickname, device ID, IP addresses, user's unique ID, etc.), and/or one or more attributes or features or values associated with the one or more identifications. Any user's identification(s) and/or user's data described in this document are allowed, permitted, and/or otherwise authorized by the user for use in the embodiments described herein and in their proper legal equivalents as understood by those of skill in the art.

User data included in datasets referenced throughout this disclosure are collected, processed, and maintained in accordance with applicable laws, regulations and relevant provisions. The systems described herein may employ robust mechanisms to ensure that data acquisition and usage practices align with legal requirements, including obtaining explicit user consent where necessary, implementing stringent security measures to safeguard data integrity, and adhering to regional and international data protection frameworks. This commitment to lawful data handling not only protects user privacy but also enhances the overall trust and transparency of the services provided.

The term “user” as used herein may include, but is not limited to, any type of rights holder such as individuals, enterprises, or groups. Users associated with the systems described herein are informed of the type, the scope of use, the use scenario, and other relevant aspects of the personal information involved in the present disclosure in an appropriate manner, in accordance with applicable laws and regulations.

For example, in response to receiving an active request from a user, a prompt message may be sent to the user to explicitly notify them that the operation they have requested may involve obtaining and/or the use of personal information. This enables users to decide whether to provide their personal information to the relevant software or hardware components, such as an electronic device, application, server, or storage medium, that perform the operation of the technical solution disclosed herein based on the information provided in the prompt.

In some embodiments, in response to receiving the user's active request, the method of sending prompt information to the user may include, for example, displaying a pop-up window in which the prompt information is presented in text form. The pop-up window may contain selection controls that allow users to choose whether to “agree” or “disagree” to provide their personal information to the electronic devices. Such notification and user authorization acquisition process are illustrative and should not be understood to limit embodiments of the present disclosure. Other methods that comply with applicable laws and regulations may also be applied to the systems and techniques described herein.

As referenced herein, “inner join” or “inner-join” is a term of art and may refer to an operation or function that includes combining records from datasets, particularly when there are matching values in a field common to the datasets. For example, an inner join may be performed with a “Departments” dataset and an “Employees” dataset to determine all the employees in each department. In the resulting dataset (i.e., the “intersection”) of the inner join operation, the inner join may contain the information from both datasets that is related to each other. An outer join, on the other hand, may also contain information that is not related to the other dataset in its resulting dataset. A private inner join may refer to an inner join operation of datasets of two or more parties that does not reveal the data in the intersection of datasets of the two or more parties.

As referenced herein, “hashing” may refer to an operation or function that transforms or converts an input (a key such as a numerical value, a string of characters, etc.) into an output (e.g., another numerical value, another string of characters, etc.). Hashing is a term of art and may be used in cyber security application(s) to access data in a small and nearly constant time per retrieval.

As referenced herein, “MPC” or “multi-party computation” is a term of art and may refer to a field of cryptography with the goal of creating schemes for parties to jointly compute a function over the joint input of the parties while keeping respective input private. Unlike traditional cryptographic tasks where cryptography may assure security and integrity of communication or storage when an adversary is outside the system of participants (e.g., an eavesdropper on the sender and/or the receiver), the cryptography in MPC may protect participants' privacy relative to each other.

As referenced herein, “ECC” or “elliptic-curve cryptography” is a term of art and may refer to a public-key cryptography based on the algebraic structure of elliptic curves over finite fields. The ECC may allow smaller keys compared to non-EC cryptography to provide equivalent security. Further, “EC” or “elliptic curve” may be applicable for key agreement, digital signatures, pseudo-random generators, and/or other tasks. Elliptic curves may be indirectly used for encryption by combining a key agreement between/among the parties with a symmetric encryption scheme. Elliptic curves may also be used in integer factorization algorithms based on elliptic curves that have applications in cryptography.

As referenced herein, “decisional Diffie-Hellman assumption” or “DDH assumption” is a term of art and may refer to a computational complexity assumption about a certain problem involving discrete logarithms in cyclic groups. The DDH assumption may be used as a basis to prove the security of many cryptographic protocols.

As referenced herein, “elliptic-curve Diffie-Hellman” or “ECDH” is a term of art and may refer to a key agreement protocol or a corresponding algorithm that allows two or more parties, each having an elliptic-curve public-private key pair, to establish a shared secret over an unsecured channel. The shared secret may be directly used as a key or to derive another key. The key, or the derived key, may then be used to encrypt or encode subsequent communications using a symmetric-key cipher. ECDH may refer to a variant of the Diffie-Hellman protocol using elliptic-curve cryptography.

As referenced herein, “private set intersection” is a term of art and may refer to a secure multi-party computation cryptographic operation, algorithm, or function by which two or more parties holding respective datasets compare encrypted versions of these datasets in order to compute the intersection. For private set intersection, neither party reveals data elements to the counterparty except for the elements in the intersection.

As referenced herein, “shuffle,” “shuffling,” “permute,” or “permuting” is a term of art and may refer to an action or algorithm for rearranging and/or randomly rearranging the order of the records (elements, rows, etc.) of e.g., an array, a dataset, a database, a data table, etc.

As referenced herein, “differential privacy” or “DP” is a term of art and may refer to a standard, a protocol, a system, and/or an algorithm for publicly sharing information regarding a dataset by describing patterns of groups of elements within the dataset while withholding information about individual users listed in the dataset. Differential privacy may refer to a constraint on algorithms used to release aggregate information about a statistical dataset or database to a user, which limits the disclosure of private information of records for individuals whose information is in the dataset or database.

The following is a non-limiting example of the context, setting, or application of differential privacy. A trusted data owner (or data holder or curator, such as a social media platform, a website, a service provider, an application, etc.) may have stored a dataset of sensitive information about users or members (e.g., the dataset includes records/rows of users or members). Each time the dataset is queried (or operated, e.g., analyzed, processed, used, stored, shared, accessed, etc.), there may be a chance or possibility of an individual's privacy being compromised (e.g., probability of data privacy leakage or privacy loss). Differential privacy may provide a rigorous framework and security definition for algorithms that operate on sensitive data and publish aggregate statistics to prevent an individual's privacy from being compromised by, e.g., resisting linkage attacks and auxiliary information, and/or supplying a limit on a quantifiable measure of harm (privacy leakage, privacy loss, etc.) incurred by individual record(s) of the dataset.

The above aspect of the differential privacy protocol or algorithm may refer to a measure of “how much data privacy is afforded (e.g., by a single query or operation on the input dataset) when performing the operations or functions?” A DP parameter “ϵ” may refer to a privacy budget (i.e., a limit of how much data privacy it is acceptable with leaking), e.g., indicating a maximum difference between a query or operation on dataset A and the same query or operation on dataset A′ (that differs from A by one element or record). The smaller the value of ϵ is, the stronger the privacy protection is for the multi-identification privacy-protection mechanism. Another DP parameter “δ” may refer to a probability, such as a probability of information being accidentally leaked. In an example embodiment, a required or predetermined numeric value of ϵ may range from at or about 1 to at or about 3. The required or predetermined numeric value of δ may range from at or about 10⁻¹⁰ (or at about 10⁻⁸) to at or about 10⁻⁶. Yet another DP parameter sensitivity may refer to a quantified amount for how much noise perturbation may be required in the DP protocol or algorithm. To determine the sensitivity, a maximum of possible change in the result may need to be determined. That is, sensitivity may refer to an impact a change in the underlying dataset may have on the result of the query to the dataset.

As referenced herein, “differential privacy composition” or “DP composition” is a term of art and may refer to the total or overall differential privacy when querying (or operating, e.g., analyzing, processing, using, storing, sharing, accessing, etc.) a particular dataset more than once. DP composition is to quantify the overall differential privacy (which may be degraded in view of the DP of a single query or operation) when multiple separate queries or operations are performed on a single dataset. When a single query or operation to the dataset has a privacy loss L, the cumulative impact of N queries (referred to as N-fold composition or N-fold DP composition) on data privacy may be greater than L but may be lower than L*N. In an example embodiment, an N-fold DP composition may be determined based on an N-fold convolution operation of the privacy loss distribution. For example, a DP composition of two queries may be determined based on a convolution of the privacy loss distribution of the two queries. In an example embodiment, the number N may be at or about 10, at or about 25, or any other suitable number. In an example embodiment, ϵ, δ, sensitivity, and/or the number N may be predetermined to achieve a desired or predetermined data privacy protection goal or performance.

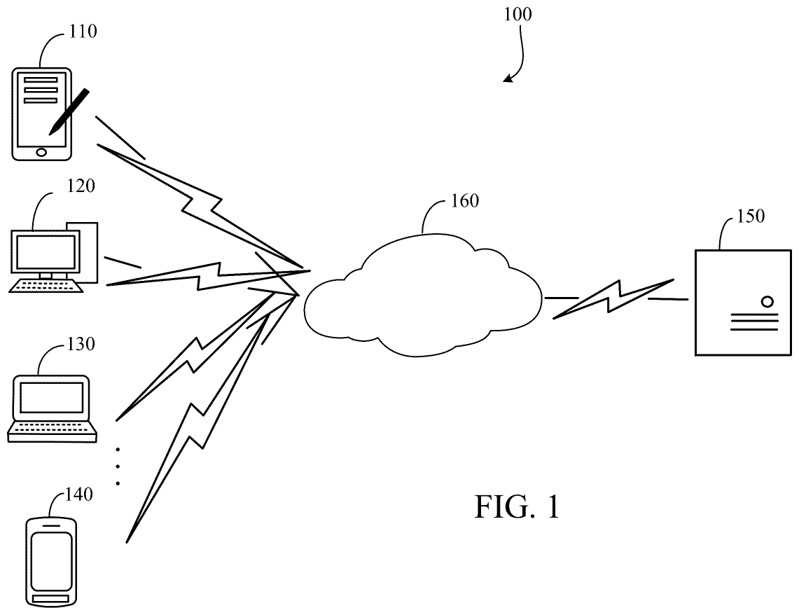

FIG. 1 is a schematic view of an example secure computation and communication system 100, arranged in accordance with at least some embodiments described herein.

The system 100 may include terminal devices 110, 120, 130, and 140, a network 160, and a server 150. FIG. 1 shows illustrative numbers of the terminal devices, the network, and the server. The embodiments described herein are not limited to the number of the terminal devices, the network, and/or the server described. That is, the number of terminal devices, networks, and/or servers described herein are provided for descriptive purposes only and are not intended to be limiting.

In accordance with at least some example embodiments, the terminal devices 110, 120, 130, and 140 may be various electronic devices. The various electronic devices may include but not be limited to a mobile device such as a smartphone, a tablet computer, an e-book reader, a laptop computer, a desktop computer, and/or any other suitable electronic devices.

In accordance with at least some example embodiments, the network 160 may be a medium used to provide a communications link between the terminal devices 110, 120, 130, 140 and the server 150. The network 160 may be the Internet, a local area network (LAN), a wide area network (WAN), a local interconnect network (LIN), a cloud, etc. The network 160 may be implemented by various types of connections, such as a wired communications link, a wireless communications link, an optical fiber cable, etc.

In accordance with at least some example embodiments, the server 150 may be a server for providing various services to users using one or more of the terminal devices 110, 120, 130, and 140. The server 150 may be implemented by a distributed server cluster including multiple instances of server 150 or may be implemented by a single server 150.

A user may use one or more of the terminal devices 110, 120, 130, and 140 to interact with the server 150 via the network 160. Various applications or localized interfaces thereof, such as social media applications, online shopping services, or the like, may be installed on the terminal devices 110, 120, 130, and 140.

Software applications or services according to the embodiments described herein and/or according to the services provided by the service providers may be performed by the server 150 and/or the terminal devices 110, 120, 130, and 140 (which may be referred to herein as user devices). Accordingly, the apparatus for the software applications and/or services may be arranged in the server 150 and/or in the terminal devices 110, 120, 130, and 140.

When a service is not performed remotely, the system 100 may not include the network 160, but include only the terminal device 110, 120, 130, and 140 and/or the server 150. The terminal device 110, 120, 130, and 140 and/or the server 150 may each include one or more processors, a memory, and a storage device storing one or more programs. The terminal device 110, 120, 130, and 140 and/or the server 150 may also each include an Ethernet connector, a wireless fidelity receptor, etc. The one or more programs, when being executed by the one or more processors, may cause the one or more processors to perform the method(s) described in any embodiments described herein. Also, a computer readable non-volatile medium may be provided according to the embodiments described herein. The computer readable medium stores computer programs. The computer programs are used to, when being executed by a processor, perform the method(s) described in any embodiments described herein.

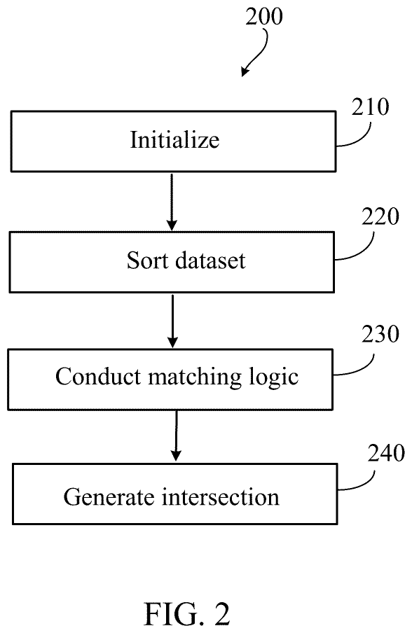

FIG. 2 is a flow chart illustrating an example processing flow 200 for a multi-identification matching algorithm, in accordance with at least some embodiments described herein. The processing flow 200 can be conducted by one or more processors (e.g., the processor of one or more of the terminal device 110, 120, 130, and 140 of FIG. 1, the processor of the server 150 of FIG. 1, the central processor unit 805 of FIG. 7, and/or any other suitable processor).

The processing flow 200 can include one or more operations, actions, or functions as illustrated by one or more of blocks 210, 220, 230, and 240. These various operations, functions, or actions may, for example, correspond to software, program code, or program instructions executable by a processor that causes the functions to be performed. Although illustrated as discrete blocks, obvious modifications may be made, e.g., two or more of the blocks may be re-ordered; further blocks may be added; and various blocks may be divided into additional blocks, combined into fewer blocks, or eliminated, depending on the desired implementation. Processing flow 200 may begin at block 210.

At block 210 (Initialize), the processor for a respective device may perform initialization functions or operations for, e.g., system parameters and/or application parameters. The processor of the respective device may provide a dataset (e.g., dataset 400A) for Party 1, and/or provide a dataset (e.g., dataset 400B) for Party 2. The datasets 400A and/or 400B may be up-sampled datasets generated or obtained according to techniques described in U.S. Pat. No. 11,886,617, the disclosure of which is incorporated by reference herein in its entirety.

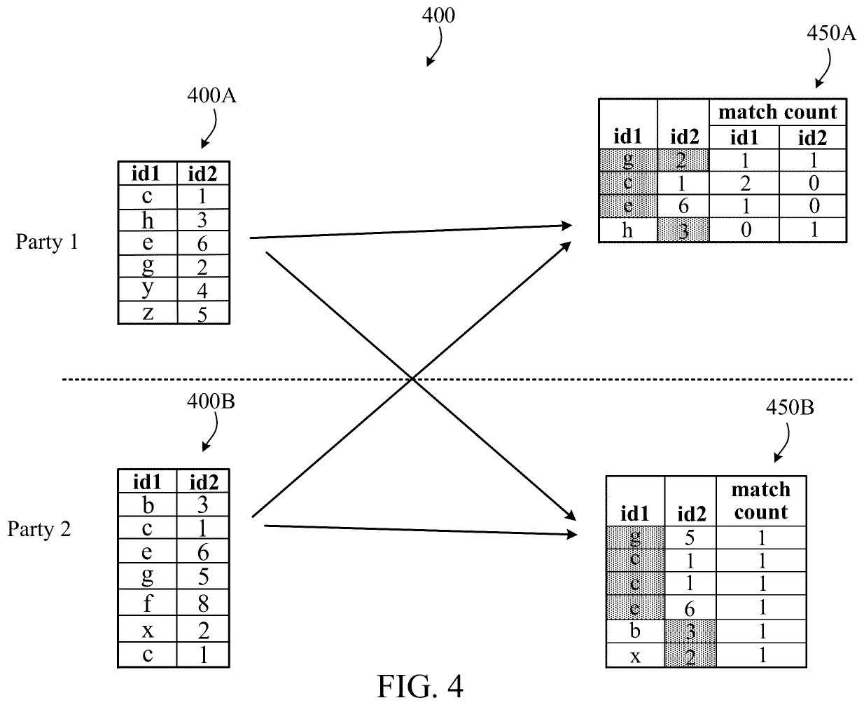

Each dataset 400A or 400B may include one or more identification (ID) fields or columns, and that the number of the identification fields or columns of the dataset 400A may or may not be equal to the number of the identification fields or columns of the dataset 400B. As shown in FIG. 4, each of the datasets 400A and 400B includes two ID fields: id1 and id2. In some scenarios, dataset 400B may include duplicate ID fields, e.g., ID fields with duplication information for multiple rows within dataset 400B. As discussed below, in such scenarios, the processor may be configured to perform duplicate ID matching to identify “multi-conversion” within the output. This is accomplished by performing “one-to-many” matching.

In an example embodiment, the processor of the respective device may shuffle the dataset 400A for Party 1 and/or shuffle the dataset 400B for Party 2. The processor may also transform the ID fields of the dataset 400A using a transforming scheme for Party 1.

The function or operation to “transform” or of “transforming” a dataset or a portion thereof, e.g., one or more fields/columns (or records/rows) of a dataset such as one or more ID fields/columns (or records/rows), etc., may refer to processing (e.g., encrypting, decrypting, encoding, decoding, manipulating, compressing, decompressing, converting, etc.) the dataset or a portion thereof. The “transforming scheme” may refer to an algorithm, protocol, or function of performing the processing (e.g., encrypting, decrypting, encoding, decoding, manipulating, compressing, decompressing, converting, etc.) of the dataset or a portion thereof. In an example embodiment, the processor may encrypt (or decrypt, encode, decode, manipulate, compress, decompress, convert, etc.) the ID fields of the dataset 400A using e.g., a key of Party 1 based on e.g., an ECDH algorithm or protocol.

The processor may also transform the ID fields of the dataset 400B using a transforming scheme for Party 2. In an example embodiment, the processor may encrypt (or decrypt, encode, decode, manipulate, compress, decompress, convert, etc.) the ID fields of the dataset 310B using e.g., a key of Party 2 based on e.g., the ECDH algorithm or protocol.

For Party 1 and/or Party 2, a sequence of the transforming of the ID fields of the dataset (400A or 400B) and the shuffling of the dataset (400A or 400B) may be switched or changed, without impacting the purpose of the resultant dataset.

The processor of the respective device may further exchange the dataset 400A with the dataset 400B between Party 1 and Party 2. For Party 1, the processor may dispatch or send the dataset 400A to Party 2 and receive or obtain the dataset 400B from Party 2. For Party 2, the processor may dispatch or send the dataset 400B to Party 1 and receive or obtain the dataset 400A from Party 1. Since the dataset 400A and the dataset 400B have been transformed (e.g., encoded, etc.), the corresponding receiving party may not know the real data in the received dataset. Each party may now have a local copy of both the dataset 400A and the dataset 400B.

The processor of the respective device may further transform the ID fields of the received transformed dataset 400B using a transforming scheme for Party 1. In an example embodiment, the processor may encrypt (or decrypt, encode, decode, manipulate, compress, decompress, convert, etc.) the ID fields of the received transformed dataset 400B using a key of Party 1 based on e.g., the ECDH algorithm or protocol. The processor of the respective device may further transform the ID fields of the received transformed dataset 400A using a transforming scheme for Party 2. In an example embodiment, the processor may encrypt (or decrypt, encode, decode, manipulate, compress, decompress, convert, etc.) the ID fields of the received transformed dataset 400A using a key of Party 2 based on e.g., the ECDH algorithm or protocol.

The processor may also shuffle the transformed received transformed dataset 400A for Party 2 and/or the transformed received transformed dataset 400B for Party 1. For Party 1 and/or Party 2, a sequence of the transforming of ID fields of the received transformed dataset (400A and/or 400B) and the shuffling of the transformed received transformed dataset (400A and/or 400B) may be switched or changed, without impacting the purpose of the resultant dataset. The processor of the respective device may exchange the resultant shuffled dataset 400A (referred to as “400A” in blocks 220-240, to simplify the description) and the resultant shuffled dataset 400B (referred to as “400B” in blocks 220-240, to simplify the description) between Party 2 and Party 1. Processing may proceed from block 210 to block 220.

At block 220 (Sort dataset), the processor of the respective device may sort the dataset 400A and/or the dataset 400B for Party 1 and/or Party 2. For example, for Party 1, the processor may sort the ID fields (id1, id2, etc.) of the dataset 400A in an order (or sequence) corresponding to a predetermined importance or priority level of the ID fields. The dataset 400A may contain ID fields such as the user's nickname (e.g., having a priority level of 3, etc.), device ID (e.g., having a priority level of 2, etc.), IP addresses (e.g., having a priority level of 4, etc.), user's unique ID (e.g., having a priority level of 1, etc.), etc. In an example embodiment, the lower the priority level number is, the more important the corresponding ID field is. Sorting the ID fields of the dataset 310A may result in the user's unique ID (e.g., having a priority level of 1, etc.) being listed as the first field/column in the dataset 400A, the device ID (e.g., having a priority level of 2, etc.) being listed as the second field/column in the dataset 400A, the user's nickname (e.g., having a priority level of 3, etc.) being listed as the third field/column in the dataset 400A, and the IP addresses (e.g., having a priority level of 4, etc.) being listed as the fourth field/column in the dataset 400A. That is, in a non-limiting example of dataset 400A, the ID fields are sorted in ascending order of the number of the priority level: user's unique ID, device ID, user names, and IP addresses.

For Party 2, the processor may sort the ID fields (id1, id2, etc.) of the dataset 400B in the same order (or sequence) corresponding to the predetermined importance or priority level of the ID fields, as the order for the dataset 400A for Party 1. The sorting of the datasets 400A and 400B is to prepare for the subsequent matching process. Processing may proceed from block 220 to block 230.

At block 230 (Conduct matching logic), with datasets 400A and 400B being sorted, the processor of the respective device may, for each ID field (starting from the ID field having the lowest priority level number, up to the ID field having the highest priority level number) of the dataset 400A, search for a match (or an inner join operation, etc.) between the dataset 400A and the dataset 400B to obtain or generate an intersection (dataset 450A of FIG. 4) for Party 1.

The searching for a match operation (or an inner join operation, etc.) includes: for each ID field of the dataset 400A (starting from the ID field having the lowest priority level number, up to the ID field having the highest priority level number) and for each identification element in the dataset 400A that matches the identification element in the dataset 400B, removing the record (or row) of the dataset 400A that contains a matched identification element, and adding or appending the removed record (or row) of the dataset 400A to the dataset 450A.

For example, as shown in FIG. 4, for the ID field id1 in the dataset 400A, the records/rows containing “g,” “c,” “e” each have a corresponding match in the dataset 400B, and such records/rows may be removed from the dataset 400A; and the removed records/rows may be added or appended to the dataset 450A. For id2 in the dataset 400A, the record/row containing “3” has a corresponding match in the dataset 400B and such record/row may be removed from the dataset 400A; and the removed record/row may be added or appended to the dataset 450A.

The processor of the respective device may, for each ID field (starting from the ID field having the lowest priority level number up to the ID field having the highest priority level number) of the dataset 400B, search for a match (or an inner join operation, etc.) between the dataset 400A and the dataset 400B to obtain or generate an intersection (dataset 400B of FIG. 4) for Party 2.

The searching for a match operation (or an inner join operation, etc.) includes: for each ID field in the dataset 400B (starting from the ID field having the lowest priority level number, up to the ID field having the highest priority level number) and for each identification element in the dataset 400B that matches the identification element in the dataset 400A, removing the record (or row) of the dataset 400B that contains the matched identification element, and adding or appending the removed record (or row) of the dataset 400B to the dataset 255B.

For example, as shown in FIG. 4, for the ID field id1 in the dataset 400B, the records/rows containing “g,” “c,” “e” each has a corresponding match in the dataset 400A, and such records/rows may be removed from the dataset 400B; and the removed records/rows may be added or appended to the dataset 450B. For id2 in the dataset 400B, the record/row containing “3” has a corresponding match in the dataset 400A and such record/row may be removed from the dataset 400B; and the removed record/row may be added or appended to the dataset 450B.

The conducting matching logic/algorithm operations may be performed until all ID fields of the dataset 400A are processed for Party 1, and/or all ID fields of the dataset 400B are processed for Party 2. Processing may proceed from block 230 to block 240.

At block 240 (Generate intersection), the processor of the respective device may generate the intersection/dataset 450A for Party 1 when all ID fields of the dataset 400A are processed. The processor of the respective device may generate the intersection/dataset 450B for Party 2 when all ID fields of the dataset 400A are processed.

The intersections 450A and/or 450B may be used for further MPC processing such as generating secret shares based on the intersections 450A and/or 450B, gathering secret shares, and/or generating the results by combining gathered secret shares, etc.

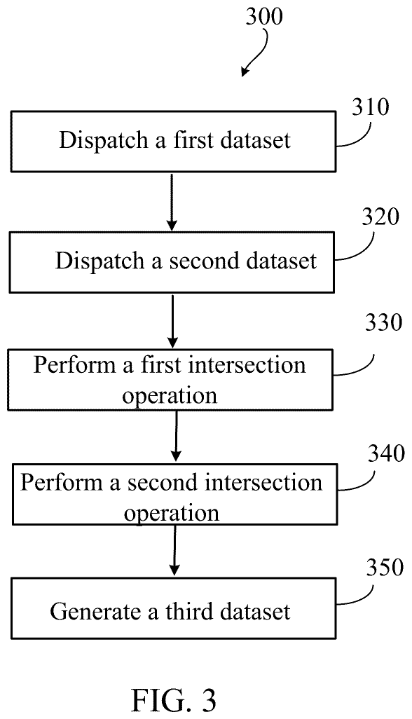

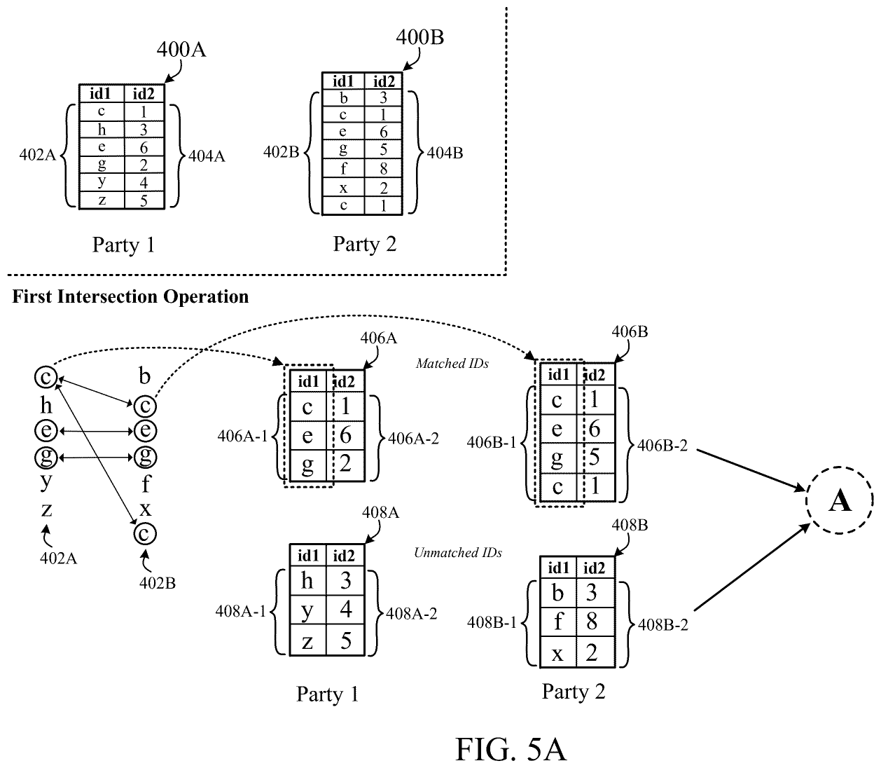

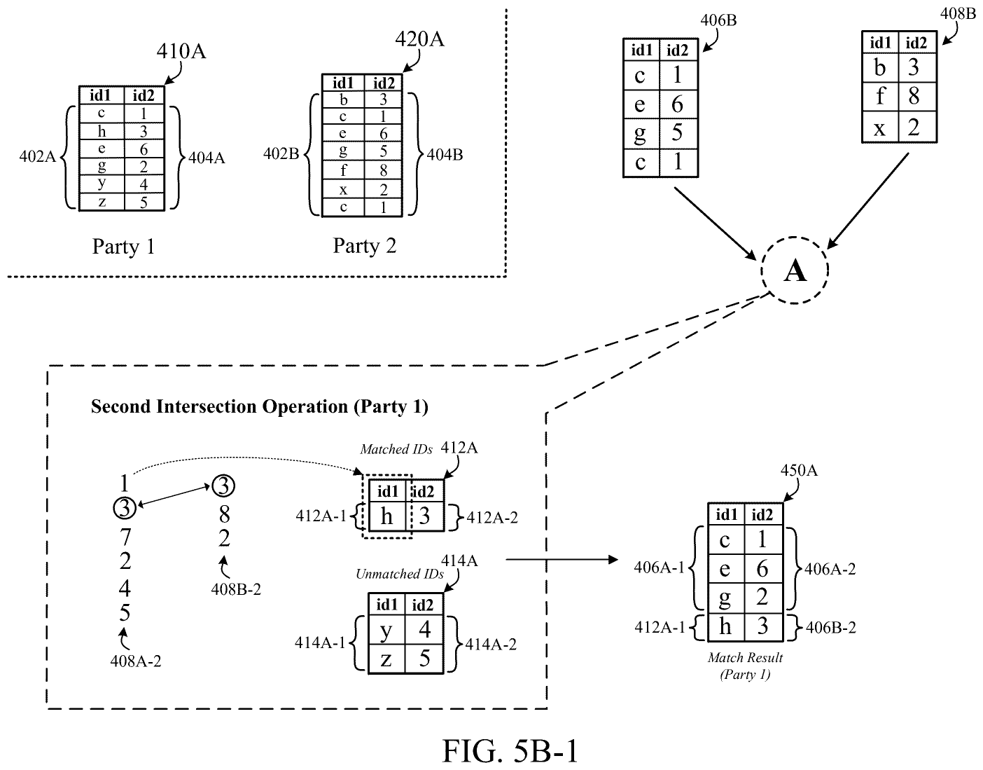

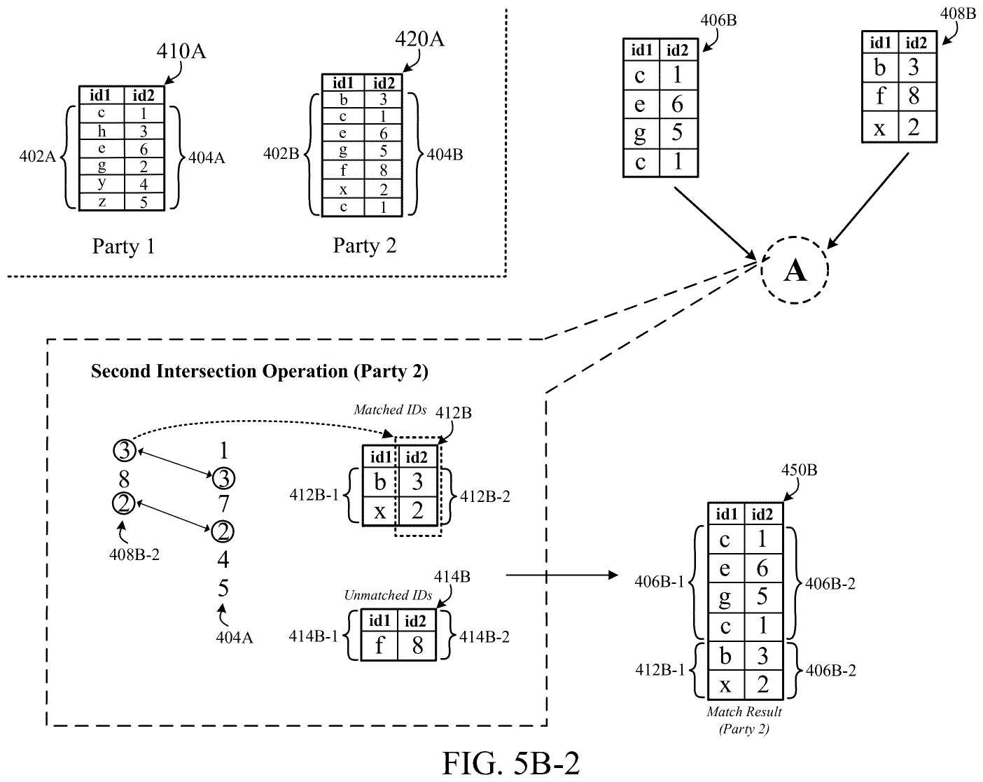

FIG. 3 is a flow chart illustrating an example processing flow 300 for matching logic enabling multi-conversion matching, in accordance with at least some embodiments. FIG. 4 is a schematic diagram 400 illustrating an example of the processing flow of FIG. 3. FIGS. 5A, 5B-1, and 5B-2 show portions of a schematic diagram 500 illustrating another example of the processing flow 300 of FIG. 3. The description of processing flow 300 below is in reference to elements of diagrams 400 and 500 shown in FIG. 4 and FIGS. 5A, 5B-1, and 5B2, respectively.

The processing flow 300 can be conducted by one or more processors (e.g., the processor of one or more of the terminal device 110, 120, 130, and 140 of FIG. 1, the processor of the server 150 of FIG. 1, the central processor unit 805 of FIG. 7, and/or any other suitable processor). The processing flow 300 can include one or more operations, actions, or functions as illustrated by one or more of blocks 310, 320, 330, 340, and 350. These various operations, functions, or actions may, for example, correspond to software, program code, or program instructions executable by a processor that causes the functions to be performed. Although illustrated as discrete blocks, obvious modifications may be made, e.g., two or more of the blocks may be re-ordered; further blocks may be added; and various blocks may be divided into additional blocks, combined into fewer blocks, or eliminated, depending on the desired implementation.

In some embodiments, blocks 310, 320, 330, 340, and 350 are performed as sub-operations of block 230 of the processing flow 200 of FIG. 2. As discussed below, in such embodiments, processing flow 300 improves the identification of “multi-conversion” within usage datasets. In the context of PSI operations, “multi-conversion” refers to scenarios where a single user performs multiple valuable actions as a result of an advertising campaign. These conversions can include a variety of actions, such as making a purchase, signing up for a newsletter, downloading a brochure, or any other activity that may be deemed significant.

Processing flow 300 may begin at block 310. At block 310, the processor for a respective device may dispatch a first dataset (e.g., dataset 400A) for Party 1. The first dataset may be an up-sampled dataset generated or obtained by the processor. At block 320, the processor may dispatch a second dataset (e.g., dataset 400B) for Party 2. The second dataset may be an up-sampled dataset generated or obtained by the processor.

At block 330, the processor may perform a first intersection operation based on the first dataset and the second dataset. As shown in FIG. 5A, the first intersection operation may be performed for a first ID field (e.g., id1) in datasets 400A and 400B. The processor may identify identifiers 402A of the first ID field within dataset 400A and identifiers 402B of the second ID field within dataset 400B. In this example, identifiers 402A include six identifiers (“c,” “h,” “e,” “g,” “y,” “z”), and identifiers 402B include seven identifiers (“b,” “c,” “e,” “g,” “f,” “x,” “c”). Dataset 400B may be constructed to include duplicate identifiers for ID fields (e.g., two rows with “c” for id1 and “1” for id2) to enable identification of multi-conversion events, as discussed throughout. For example, in some instances, dataset 400A may be associated with a party that is an advertisement publisher such that dataset 400A does not include duplicate identifiers. In such instances, dataset 400B may be associated with a party that is an advertiser such that dataset 400B includes duplicate identifiers.

In the example shown in FIG. 5A, the first intersection operation results in datasets that identify matched and unmatched identifiers between datasets 400A and 400B for each Party. Dataset 406A is identified for Party 1 and includes matched identifiers 406A-1 and corresponding identifiers of id2 in the same row within dataset 400A (e.g., identifiers 406A-2). For example, dataset 406A includes three identifiers of id1 (“c,” “e,” “g”) based on these identifiers being matched to corresponding identifiers within identifiers 402B, and three corresponding identifiers of id2 (“1,” “6,” “2”). Dataset 408A includes unmatched identifiers 408A-1 and corresponding identifiers of id2 within the same row within dataset 400A (e.g., identifiers 408A-2). For example, dataset 408A includes three identifiers of id1 (“h,” “y,” “z”) based on these identifiers not being matched to any identifiers within identifiers 402B, and three corresponding identifiers of id2 (“3,” “4,” “5”).

Additionally, dataset 406B is identified for Party 2 and includes matched identifiers 406B-1 and corresponding identifiers of id2 in the same row within dataset 400A (e.g., identifiers 406B-2). For example, dataset 406B includes four identifiers of id1 (“c,” “e,” “g,” “c”) based on these identifiers being matched to corresponding identifiers within identifiers 402A, and four corresponding identifiers of id2 (“1,” “6,” “5,” “1”). Dataset 408B includes unmatched identifiers 408B-1 and corresponding identifiers of id2 within the same row within dataset 400A (e.g., identifiers 408B-2). For example, dataset 408B includes three identifiers of id1 (“b,” “f,” “x”) based on these identifiers not being matched to any identifiers within identifiers 402A, and three corresponding identifiers of id2 (“3,” “8,” “2”). Upon completion of the first intersection operation, the processing flow shown in FIG. 5A proceeds to portion “A” (shown in greater detail in FIGS. 5B-1 and 5B-2).

At block 340, the processor may perform a second intersection operation based on a result of the first intersection operation. The second intersection operation may be performed for a second ID field (e.g., id2) for datasets of each Party (e.g., Party 1, Party 2), as shown in FIGS. 5B-1 and 5B-2, respectively.

Referring initially to FIG. 5B-1, the second intersection operation for Party 1 is shown. The processor may identify identifiers 408A-2 of the second ID field within dataset 400A and identifiers 408B-2 of the second ID field within dataset 400B based on the result of the first intersection operation (e.g., shown in FIG. 5A). In this example, identifiers 408A-2 include six identifiers (“1,” “3,” “7,” “2,” “4,” “5”), and identifiers 408B-2 include three identifiers (“3,” “8,” “2”).

In the example shown in FIG. 5B-1, the second intersection operation for Party 1 results in datasets that identify matched and unmatched identifiers between identifiers 408A-2 and 408B-2. Dataset 412A includes matched identifiers 412A-1 and corresponding identifiers of id2 in the same row within dataset 400A (e.g., identifiers 412A-2). For example, dataset 412A includes one identifier of id1 (“h”) based on this identifier being matched to a corresponding identifier within identifiers 408B-2, and one corresponding identifier of id2 (“3”). Dataset 414A includes unmatched identifiers 414A-1 and corresponding identifiers of id2 within the same row within dataset 400A (e.g., identifiers 414A-2). For example, dataset 414A includes two identifiers of id1 (“y,” “z”) based on these identifiers not being matched to any identifiers within identifiers 408B-2, and two corresponding identifiers of id2 (“4,” “5”).

Referring now to FIG. 5B-2, the second intersection operation for Party 2 is shown. The processor may identify identifiers 408B-2 of the second ID field within dataset 400B and identifiers 404A of the second ID field within dataset 400A based on the result of the first intersection operation (e.g., shown in FIG. 5A). In this example, unlike dataset 400A, dataset 400B includes duplicate rows. As shown in FIG. 5B-2, to enable the identification of multi-conversion events, the second intersection operation performed for Party 2 involves matching of identifiers 408B-2 (identified based on the result of the first intersection operation) and each of the identifiers of the second ID field (id2) within dataset 610A (e.g., identifiers 404A). Using this matching protocol (where entire records from dataset 400A are used for intersection operations performed for Party 2) multi-conversion events may be identified within dataset 400B. For example, as shown in FIG. 4, dataset 450B includes two duplicate rows (e.g., “c” for id1, “1” for id2) representing possible multi-conversion events within dataset 400B.

As shown in FIG. 5B-2, identifiers 408B-2 include three identifiers (“3,” “8,” “2”), and identifiers 404A includes six identifiers (“1,” “3,” “7,” “2,” “4,” “5”). In the example shown in FIG. 5B-2, the second intersection operation for Party 2 results in datasets that identify matched and unmatched identifiers between identifiers 408B-2 and 404A. Dataset 412B includes matched identifiers 412B-1 and corresponding identifiers of id2 in the same row within dataset 400B (e.g., identifiers 412B-2). For example, dataset 412B includes two identifier of id1 (“b,” “x”) based on these identifiers being matched to corresponding identifiers within identifiers 404A, and two corresponding identifiers of id2 (“3,” “2”). Dataset 414B includes unmatched identifiers 414B-1 and corresponding identifiers of id2 within the same row within dataset 400B (e.g., identifiers 414B-2). For example, dataset 414B includes one identifier of id1 (“f”) based on this identifier not being matched to any identifiers within identifiers 404A, and a corresponding identifier of id2 (“8”).

At block 350, the processor may generate a third dataset representing a match result. The processor may generate datasets for each Party associated with input datasets used for matching (e.g., Party 1, Party 2). For example, the processor may generate dataset 450A (e.g., shown in FIG. 4, 5B-1) to represent match results for Party 1. As another example, the processor may generate dataset 450B (e.g., shown in FIG. 4, 5B-2) to represent match results for Party 2.

Datasets representing match results may be generated by combining rows of input datasets that were identified through intersection operations (e.g., shown in FIGS. 5A, 5B-1, 5B-2) to be matched between datasets of two parties (e.g., Party 1, Party 2). For example, as shown in FIG. 5B-1, dataset 420A includes identifiers 406A-1 for a first ID field (e.g., id1) and corresponding identifiers 406A-2 for a second ID field (e.g., id2) based on the result of the first intersection operation for Party 1 shown in FIG. 5A. Dataset 420A also includes identifiers 412A-1 for the first ID field (e.g., id1) and corresponding identifiers 412A-2 for the second ID filed (e.g., id2) based on the result of the second intersection operation for Party 1 shown in FIG. 5B-1. The dataset 450A includes four identifiers for ID field id1 (“c,” “e,” “g,” “h”) and four corresponding identifiers for ID field id2 (“1,” “6,” “2,” “3”).

Datasets 450A and 450B include match counts indicating the results of intersection operations performed between datasets 400A and 400B (shown in detail in FIGS. 5A, 5B-1, and 5B-2). The match counts identify a number of identifiers from one dataset (e.g., dataset 400A) that is present in another dataset (e.g., dataset 400B). For example, as shown in FIG. 4, dataset 450A includes a match count of “1” for the id1 identifier “g” since this identifier is present one time within dataset 400B. Further, if multiple records with duplicate identifiers in dataset 400B are matched within one record in dataset 400A, the match count value in dataset 450A can be used to reflect these duplicate identifiers. For example, as shown in FIG. 4, dataset 450A includes a match count of “2” for the id1 identifier “c” since dataset 400B includes two records with duplicate identifiers (e.g., a first record with id1 “c1” and id2 “1,” and a second record with id1 “c” and id2 “1”). In this way, match counts within dataset 450A can be used to identify a multi-conversion event. As discussed herein, this is possible because dataset 450B includes two duplicate rows (e.g., “c” for id1, “1” for id2) representing possible multi-conversion events within dataset 400B and matching technique (shown in FIGS. 5A, 5B-1, 5B-2) does not involve removing duplicate rows from dataset 400B.

Additionally, as shown in FIG. 5B-2, dataset 450B includes identifiers 406B-1 for a first ID field (e.g., id1) and corresponding identifiers 406B-2 for a second ID field (e.g., id2) based on the result of the first intersection operation for Party 2 shown in FIG. 5A. Dataset 450B also includes identifiers 412B-1 for the first ID field (e.g., id1) and corresponding identifiers 412B-2 for the second ID filed (e.g., id2) based on the result of the second intersection operation for Party 2 shown in FIG. 5B-2. The dataset 450B includes six identifiers for ID field id1 (“c,” “e,” “g,” “c,” “b,” “x”) and six corresponding identifiers for ID field id2 (“1,” “6,” “5,” “1,” “3,” “2”). As explained previously, dataset 450B includes two duplicate rows (e.g., “c” for id1, “1” for id2) representing possible multi-conversion events within dataset 400B.

In some embodiments, datasets 400A, 400B (shown in FIG. 4) may be processed according to a multi-conversion anonymous private set intersection protocol that includes data processing techniques similar to those described in U.S. Pat. No. 11,886,617, the disclosure of which is incorporated by reference herein in its entirety. For example, datasets from Party 1 and Party 2 (e.g., datasets 400A, 400B in FIG. 4) may be initially processed in relation to a common dummy set. Each column of the dummy data is shuffled by row independently.

In the example discussed above, during the first intersection operation (shown in FIG. 5A), encrypted and shuffled-by-row data is sent to each of Party 1 and Party 2. Data associated with a first identifier column (e.g., a column associated with id1) is double encrypted and then shuffled prior to being provided back to the other party. A blind match is then performed on the first identifier column. As shown in FIG. 5B-1, the results of the blind match are then used to remove rows from the Party 1 dataset that have been matched. As previously discussed, rows from the Party 2 dataset that have been matched are not removed.

Further, in the example discussed above, during the second intersection operation (shown in FIG. 5B-1 for Party 1, and FIG. 5B-2 for Party 2), encrypted and shuffled-by-row data is sent to each of Party 1 and Party 2. Data associated with a second identifier column (e.g., a column associated with id2) is double encrypted and then shuffled prior to being provided back to the other party. A blind match is then performed on the second identifier column.

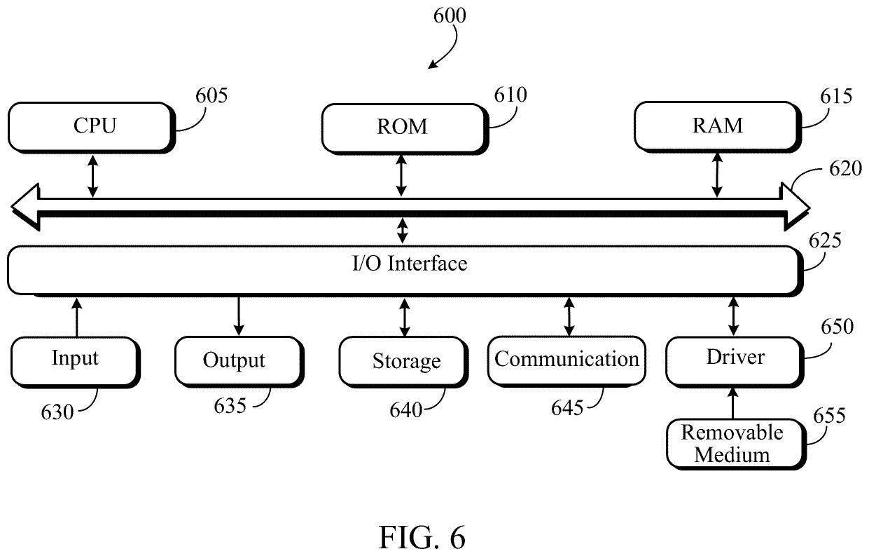

FIG. 6 is a schematic structural diagram of an example computer system 800 applicable to implementing an electronic device (for example, the server or one of the terminal devices shown in FIG. 1), arranged in accordance with at least some embodiments described herein. The computer system shown in FIG. 6 is provided for illustration only instead of limiting the functions and applications of the embodiments described herein.

As depicted, the computer system 600 may include a central processing unit (CPU) 605. The CPU 605 may perform various operations and processing based on programs stored in a read-only memory (ROM) 610 or programs loaded from a storage device 640 to a random-access memory (RAM) 615. The RAM 615 may also store various data and programs required for operations of the system 600. The CPU 605, the ROM 610, and the RAM 615 may be connected to each other via a bus 620. An input/output (I/O) interface 625 may also be connected to the bus 620.

The components connected to the I/O interface 625 may further include an input device 630 including a keyboard, a mouse, a digital pen, a drawing pad, or the like; an output device 635 including a display such as a liquid crystal display (LCD), a speaker, or the like; a storage device 640 including a hard disk or the like; and a communication device 645 including a network interface card such as a LAN card, a modem, or the like. The communication device 645 may perform communication processing via a network such as the Internet, a WAN, a LAN, a LIN, a cloud, etc. In an embodiment, a driver 650 may also be connected to the I/O interface 625. A removable medium 655 such as a magnetic disk, an optical disk, a magneto-optical disk, a semiconductor memory, or the like may be mounted on the driver 650 as desired, such that a computer program read from the removable medium 655 may be installed in the storage device 640.

The processes described with reference to the flowcharts of FIGS. 2, 4A, and 4B and/or the processes described in other figures may be implemented as computer software programs or in hardware. The computer program product may include a computer program stored in a computer readable non-volatile medium. The computer program includes program codes for performing the method shown in the flowcharts and/or GUIs. In this embodiment, the computer program may be downloaded and installed from the network via the communication device 645, and/or may be installed from the removable medium 655. The computer program, when being executed by the central processing unit (CPU) 605, can implement the above functions specified in the method in the embodiments disclosed herein.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., a field programmable gate array, an application specific integrated circuit, or the like.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory, electrically erasable programmable read-only memory, and flash memory devices; magnetic disks, e.g., internal hard disks or removable disks; magneto optical disks; and compact disc read-only memory and digital video disc read-only memory disks. The processor and the memory can be supplemented by, or incorporated in, special purpose logic circuitry.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. This disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

What is claimed is:

1. A method of performing intersection operations comprising:
dispatching a first dataset that includes (i) a first set of identifications of a first identification field, and (ii) a second set of identifications of a second identification field;
dispatching a second dataset that includes (i) a third set of identifications of the first identification field, and (ii) a fourth set of identifications of the second identification field;
performing a first intersection operation based on the first dataset and the second dataset, wherein the first intersection operation comprises:
identifying a first subset of identifications from among the third set of identifications, wherein the first subset of identifications comprises each identification of the first identification field that matches an identification in the first set of identifications,
identifying a second subset of identifications from among the third set of identifications, wherein the second subset of identifications comprises each identification of the first identification field that does not match an identification in the first set of identifications,
identifying, from amongst the fourth set of identifications, a third subset of identifications that correspond to the first subset of identifications within the second dataset;
identifying, from amongst the fourth set of identifications, a fourth subset of identifications that correspond to the second subset of identifications within the second dataset;
performing a second intersection operation based on the fourth subset of identifications, wherein the second intersection operation comprises:
identifying a fifth subset of identifications from among the fourth subset of identifications, wherein the fifth subset of identifications comprises each identification of the second identification field that matches an identification of the second set of identifications, and
identifying, from amongst the third set of identifications, a sixth subset of identifications that correspond to the fifth subset of identifications within the second dataset; and
generating a third dataset based on the first subset of identifications, the second subset of identifications, the fifth subset of identifications, and the sixth subset of identifications.

2. The method of claim 1, further comprising:
generating a first share based on the third dataset; and
constructing a result based on the first dataset and a second share.

3. The method of claim 2, further comprising:
performing an oblivious transfer to generate a first noise data; and
applying the first noise data to the first share.

4. The method of claim 3, wherein:
the performing of the oblivious transfer includes generating a second noise data; and
the method further comprises applying the second noise data to the second share.

5. The method of claim 1, further comprising:
generating a padding dataset, a size of the padding dataset being determined based on a data privacy configuration.

6. The method of claim 5, wherein:
the data privacy configuration includes a first parameter and a second parameter; and
wherein the size of the padding dataset is determined such that the first intersection operation and second intersection operation are differentially private based on the first parameter and the second parameter.

7. The method of claim 5, wherein the size of the padding dataset is determined based on a number of identification fields of the first dataset.

8. The method of claim 7, wherein the size of the padding dataset is determined further based on a number of intersection operations.

9. The method of claim 5, wherein:
the first dataset is up-sampled with the padding dataset by inserting elements of the padding dataset and random elements into a first baseline dataset; and
the second dataset is up-sampled with the padding dataset by inserting elements of the padding dataset and random elements into a second baseline dataset.

10. The method of claim 1, wherein:
the first dataset is associated with a first party;
the second dataset is associated with a second party;
the first dataset is dispatched such that personally identifiable information associated with the first dataset is not accessible by the second party; and
the first dataset is dispatched such that personally identifiable information associated with the second dataset is not accessible by the first party.

11. The method of claim 1, wherein:
the first dataset is constructed such that the first set of identifications and the second set of identifications do not include any duplicate identifications;
the second dataset is constructed such that the third set of identifications and the fourth set of identifications each include duplicate identifications; and
the third dataset comprises one or more identifications reflecting a multi-conversion event.

12. A secure multi-party computation and communication system, comprising:
a memory configured to store a first dataset;
a processor configured to:
generate a padding dataset, a size of the padding dataset being determined based on a data privacy configuration;
up-sample the first dataset with the padding dataset by inserting elements of the padding dataset and random elements into the first dataset;
transform the first dataset;
dispatch the first dataset;
perform a first intersection operation based on the first dataset and a second dataset to identify a subset of identifications from the second dataset;
perform a second intersection operation based on the subset of identifications and identifications included in the first dataset to generate a third dataset, wherein the third dataset comprises one or more identifications reflecting a multi-conversion event, wherein the second intersection operation is performed such that identifications included in the first dataset are not removed prior to matching identifications included in the subset of identifications;
generate a first share based on the third dataset; and
construct a result based on the first share and a second share.

13. The secure multi-party computation and communication system of claim 12, wherein:
the first dataset is associated with a first party;
the second dataset is associated with a second party;
the first dataset is constructed such that personally identifiable information associated with the first dataset is not accessible by the second party; and
the first dataset is constructed such that personally identifiable information associated with the second dataset is not accessible by the first party.

14. The secure multi-party computation and communication system of claim 12. wherein:
the first dataset is constructed such that the first dataset does not include any duplicate identifications; and
the second dataset is constructed such that the second dataset includes duplicate identifications.

15. A non-transitory, computer-readable medium having computer-executable instructions stored thereon that, upon execution, cause one or more processors to perform operations comprising:
dispatching a first dataset that includes (i) a first set of identifications of a first identification field, and (ii) a second set of identifications of a second identification field;
dispatching a second dataset that includes (i) a third set of identifications of the first identification field, and (ii) a fourth set of identifications of the second identification field;
performing a first intersection operation based on the first dataset and the second dataset, wherein the first intersection operation comprises:
identifying a first subset of identifications from among the third set of identifications, wherein the first subset of identifications comprises each identification of the first identification field that matches an identification in the first set of identifications,
identifying a second subset of identifications from among the third set of identifications, wherein the second subset of identifications comprises each identification of the first identification field that does not match an identification in the first set of identifications,
identifying, from amongst the fourth set of identifications, a third subset of identifications that correspond to the first subset of identifications within the second dataset;
identifying, from amongst the fourth set of identifications, a fourth subset of identifications that correspond to the second subset of identifications within the second dataset;
performing a second intersection operation based on the fourth subset of identifications, wherein the second intersection operation comprises:
identifying a fifth subset of identifications from among the fourth subset of identifications, wherein the fifth subset of identifications comprises each identification of the second identification field that matches an identification of the second set of identifications, and
identifying, from amongst the third set of identifications, a sixth subset of identifications that correspond to the fifth subset of identifications within the second dataset; and
generating a third dataset based on the first subset of identifications, the second subset of identifications, the fifth subset of identifications, and the sixth subset of identifications.

16. The non-transitory, computer-readable medium of claim 15, wherein the operations further comprise:
generating a first share based on the third dataset; and
constructing a result based on the first dataset and a second share.

17. The non-transitory, computer-readable medium of claim 16, wherein the operations further comprise:
performing an oblivious transfer to generate a first noise data; and
applying the first noise data to the first share.

18. The non-transitory, computer-readable medium of claim 17, wherein:
the performing of the oblivious transfer includes generating a second noise data; and
the operations further comprise applying the second noise data to the second share.

19. The non-transitory, computer-readable medium of claim 15, wherein the operations further comprise:
generating a padding dataset, a size of the padding dataset being determined based on a data privacy configuration.

20. The non-transitory, computer-readable medium of claim 19, wherein:
the data privacy configuration includes a first parameter and a second parameter; and
wherein the size of the padding dataset is determined such that the first intersection operation and second intersection operation are differentially private based on the first parameter and the second parameter.
